(19) United States
(12) Patent Application Publication
(10) Pub. No.: US 2020/0406125 A1
(43) Pub. Date: Dec. 31, 2020

(54) METHOD AND APPARATUS FOR CONDUCTING A WAGERING PROCESS

(71) Applicant: CLUB GAMING PTY LTD, Southbank (AU)

(72) Inventors: Matthew TSANG, Belmore (AU); Timothy William BARNETT, Malvern East (AU); Joseph Ronald CREPALDI, Potts Point (AU); Daryl Leigh BRUCE, Croydon South (AU); Paula Jean STEWART, Roxburgh Park (AU); Arthur Phillip GREEN, Point Cook (AU); Bradley Michael WALDRON, Altona North (AU); James Geoffrey ALEXANDER, Bentleigh East (AU)

(21) Appl. No.: 16/334,604

(22) PCT Filed: Sep. 19, 2017
(86) PCT No.: PCT/AU2017/000200

§ 371 Date: Mar. 19, 2019

(30) Foreign Application Priority Data
Sep. 20, 2016 (AU) 2016903794

(51) Int. Cl. A63F 9/04; G06F 7/58; G07F 17/32

(52) U.S. Cl. CPC A63F 9/0415; A63F 9/0406; G06F 7/588; A63F 2009/0426; G07F 17/3265; G07F 17/3267; G07F 17/322

(57) ABSTRACT

The present invention in one form provides apparatus for conducting a wagering process including a number of playing dice, a playfield adapted for use of the dice, the playfield including a wagering layout having indicia representing a number of different final game results, and retaining means for retaining selected dice according to the outcome of a first cast of the dice matching one or more first criteria and, for any remaining dice after the first cast, retaining further selected dice according to the outcome of the first cast of the dice together with the outcome of one or more successive casts of the remaining dice matching one or more successive criteria, respectively.

### RELATED APPLICATIONS

This application claims priority to Australian Provisional Patent Application No. 2016903794 in the name of Crown Melbourne Limited, which was filed on 20 Sep. 2016, entitled “Method and Apparatus for Conducting a Wagering Process” and the specification thereof is incorporated herein by reference in its entirety and for all purposes.

### FIELD OF INVENTION

The present invention relates to a method and apparatus for playing a dice game and, more particularly, to a method and apparatus for playing a dice game that provides multiple wagering options and allows for active player participation. The invention may find application in casinos, gaming venues, cruise ships and online gambling sites.

### BACKGROUND ART

The discussion throughout this specification comes about due to the realisation of the inventor and/or the identification of certain related art problems by the inventor and, moreover, any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

In order to attract new players, and maintain the interest of existing patrons, casinos and other gaming operators periodically offer new games of skill and chance utilising different chance mediums, such as cards, rotating reels in slot machines, rotating wheels in roulette, or dice, for example. A majority of the new games do not find popular appeal amongst players, and the reasons for such failures typically relate to common wagering game shortcomings. Typical shortcomings include slow pace of play, complex rules, poor player odds and, in some cases, the lack of a significant jackpot or large payout opportunity. Particular drawbacks include a lack of player interaction and a lack of ease of play for patrons that will avoid the drop off in interest that can apply to games with high levels of complexity. In combination, a lack of interaction with high complexity will lower the appeal of games.

Consider, for example, the game of Casino War™ which is a casino card game based on the well-known card game called “War”. The game is one of the most easily understood casino card games, and is one of the only card games where players can beat the dealer more than fifty-percent of the time. The game has the advantages that it is easy to learn, is fast paced, and provides a high frequency of winning for the player. As a result, it has succeeded as a game for new players, particularly with those unfamiliar with table games. However, due to its simplicity the game lacks suspense and is not very exciting for players. Moreover, the game has limited player interaction and does not provide a good range of betting options.

Another game that has found success amongst new players unfamiliar with table games is the “Big Wheel”, where a large vertically oriented wheel is divided into sections, and each section is represented by a symbol. The game is very easy to learn, it is suspenseful and exciting, allows for multiple bets, and provides a range of payout odds. Regrettably, however, due to the nature of the wheel it spins slowly, which is not optimal for both player interest and gaming operator turnover.

Numerous card games exist. Many players, however, do not wish to invest the time necessary to learn all of these games, including their intricate set of house-specific variations. Further, many players find these card games slow and inactive. Some games are objected to by players because play is against other players, and not against the house.

A game that is fast and offers much player excitement is the dice game known as “Craps”. This game involves the throwing of two die. Unfortunately, the game is complex and difficult to learn, deterring many from playing it. For the gaming operator, Craps is also relatively labour intensive, typically requiring four staff dedicated to a table, where other table games may require only one. Casino floor space is a valuable asset, but a Craps table requires double the space required by, for example, a Blackjack table. Moreover, staff training is more complicated due to betting and payout complexities.

There are a number of table game variations available that are not adapted to or made in standard sizes and may require the buyer to purchase a full table of customised design and dimensions.

Other example games are disclosed in the following prior art publications.

US patent publication No. 2008/0012231 (Dargue) discloses a draw poker game offering multiple redraws in which multiple re-rolls (or re-deals) are allowed to form further poker hands. The player can place bets on an initial and subsequent poker hands with payouts based on a number of elements that are re-activated (re-rolled or re-dealt). An optional sixth element (e.g., die) can be used wherein wagers can also be placed on its outcome as a side wager, only. In particular, the disclosure of Dargue shows that players place their wagers on respective betting areas, after which, the player (or a dealer) rolls five dice to form a first poker hand. The placed wagers are resolved based on an outcome of the first dice roll of five dice. The method proceeds wherein the player selects which dice (or die) out of all the five dice (typically, either three dice, two dice or one die) to re-roll. The player can do this by indicating to the dealer which dice (or die) he has selected. The player can select any number of dice to re-roll, or alternatively can be limited in the number (e.g., the player can only re-roll 1 to 3 dice). Additional wagers are then received. For example, player(s) can now place wagers (at their discretion) in other rows designated in the betting areas (for example, the draw 3 dice row 204, the draw 2 dice row 206 or the draw 1 die row 208). The player is wagering herein on a second poker hand to be formed. A particular row or rows (corresponding to sections on the playing field) can be used depending on how many dice are selected by the player to be re-rolled. Typically, the player would make the wager in knowing how many dice (or die) the player will select to re-roll. Accordingly, the player (or the dealer) re-rolls the selected dice (or die) to form a second poker hand. The additional wagers are then resolved based on the outcome of the second roll of the dice to form the additional hand. The method can proceed to an operation which determines whether the game is over. The player may continue to re-roll an infinite or finite number of tries. Additionally (or alternatively), the game can continue until a terminating condition occurs. For example, a terminating condition can be when five aces (or another predetermined hand) is the last resulting hand that was rolled. Another terminating condition can be whether a particular image (e.g., a “sting” image) appears on the sixth die (if the sixth die is used). Another terminating condition can be whether the shooter chooses to fold (not to roll any more). Thus, in operation, if a terminating condition has not occurred, then the method can return to where the player can continue to make additional wagers and re-roll the dice. If a terminating condition has occurred, then the game can end. Essentially, Dargue offers options to wager multiple times after the initial wager on the same round of play. A total of up to 56 betting options are, in fact, offered by Dargue for players. As a result, players need to choose what and how many dice/cards to keep and to roll, which places onus and complexity upon the players.

U.S. Pat. No. 7,032,901 (Perrie et al) discloses an adaptation of the conventional home game of YAHTZEE to the casino environment as a bonusing game in a variety of embodiments in which there is a need to adapt fixed and variable scores, varying times taken to play from 1 to 13 hands and the requisite skill of a player of conventional YAHTZEE to normal casino conditions whilst maintaining a reasonable house advantage to make the game viable for casinos. Accordingly, Perrie et al discloses a stand-alone and a bonus casino poker dice game having a plurality of dice, each of the dice having faces with a different symbol thereon to form a set of symbols on each of the plurality of dice. The method of play includes the steps of placing a wager; rolling the dice; holding none, any, or all of the rolled dice; ending the casino poker dice game when the dice are all held or when re-rolling occurs a given number of times; paying any winning combinations of symbols based on the placed wager and in response to the step of ending the game; re-rolling the non-held dice when less than all the plurality of dice are held; and repeating various of these steps until the game ends. Variations on this basic method are disclosed for stand-alone games, bonus games used in conjunction with underlying gaming machines or games, and playing a bonus game in parallel with an underlying game so that a number of hands are played. Again, there is a plethora of betting options offered by Perrie et al for players and, as a result, players need to choose what and how many dice/cards to keep and to roll, which places onus and complexity upon the players. Moreover, there is a substantial probability with hands that can be thrown where players lose with zero (0) payout, for example, see Table II where Sum of Dice <24 has a payoff of 0.

In view of the foregoing, it would thus be desirable to provide a new wagering process utilising dice that is easy to learn and play, is interactive from the player's perspective, involves no procedural decisions to be made by the player or dealer, offers multiple betting opportunities with a broad spectrum of payout values, and may be adaptable to an electronic form and/or existing table forms.

### SUMMARY OF INVENTION

It is an aim of the present invention to provide an improved method and apparatus for conducting a wagering process using multiple dice, or simulations thereof.

In particular the present invention aims to address one or more of the issues outlined hereinabove, or at least provide a useful alternative that facilitates enhanced player participation in games.

According to a first aspect of the present invention, there is provided a method of conducting a wagering process comprising the steps of:

(i) providing a playfield including a gaming layout adapted for location of a plurality of dice, and a wagering layout having indicia representing a plurality of different final game results;
(ii) accepting placement of a wager, through use of said playfield wagering layout, in relation to a selected one of the plurality of final game results;
(iii) casting a plurality of dice on said playfield so as to generate a first outcome;
(iv) determining whether the first outcome matches one or more first criteria and, if so, declaring the first outcome to be the final game result;
(v) otherwise, retaining two or more of the dice on the gaming layout and re-casting the non-retained die or dice, wherein the outcome of the retained dice together with the re-cast non-retained die or dice constitute a second outcome;
(vi) determining whether the second outcome matches one or more second criteria and, if so, declaring the second outcome to be the final game result;
(vii) otherwise, retaining one or more additional dice on the gaming layout and re-casting the non-retained die or dice, wherein the outcome of the retained dice together with the re-cast non-retained die or dice constitute the final game result; and
(viii) settling the wager on the basis of the final game result.

The term ‘playfield’ is intended to mean a zone or area depicting different betting options for a player or players. It may be a part of a physical gaming table, or depicted on an electronic display. Typically, the playfield has associated therewith a game area and a plurality of wagering layouts depicting at least one outcome of a game instance involving one or more casts of a die or dice, in relation to which the player(s) may place wagers.

Throughout the specification, reference to the term ‘die’ or ‘dice’ is meant to be interpreted as a reference either to a physical die or dice or, where the context permits, a simulation of a die or dice such as an image on a video display. The die or dice may be in the standard cube form, or other suitable three-dimensional polygon.

Similarly, reference to a ‘cast’ or ‘roll’ of a die or dice is meant to be interpreted as a reference either to an actual throw or cast of a physical die or dice to produce a random outcome, whether done by hand or through the use of a receptacle such as a cup, or a simulation thereof e.g. by a computer or electronic gaming device.

The ‘outcome’ of a roll may be determined to be the ‘rank’, being the number or symbol on a predetermined side, typically the uppermost side, of the or each physical die when it comes to rest after a cast, or a simulation thereof, for example using an electronic random number or outcome generator in the computer or electronic gaming device.

The first criteria may comprise the first outcome having none of the dice with the same rank and/or for every die there existing at least one other die with the same rank.

The step (v) may comprise retaining any dice that have the same rank as any single other die and re-casting the remaining dice with unique rank.

The second criteria may comprise the second outcome having no dice with unique rank.

The die or dice that are re-cast in step (vii) may comprise those that have a unique rank.

Preferably the plurality of dice comprises five standard six-sided dice.

In one form of the invention the final game results comprise:

(a) five dice consisting of five dice of the same rank;
(b) five dice consisting of four dice of the same rank and an additional die not of the same rank as the other four dice;
(c) five dice consisting of three dice of the same rank and an additional two dice of the same rank as each other but not the other three dice;
(d) five dice consisting of three dice of the same rank and an additional two dice not of the same rank as each other or the other three dice;
(e) five dice consisting of two dice of the same rank, a further two dice of the same rank as each other but not the first two dice and an additional die not of the same rank as the other four dice;
(f) five dice consisting of two dice of the same rank and an additional three dice not of the same rank as each other or the other two dice;
(g) five dice of consecutive rank where no two dice have the same rank and 1 and 6 are not consecutive ranks.
(h) any combination of five dice that does not constitute a result as defined in (a) to (g).

In a further aspect of the invention there is provided apparatus for conducting a wagering process comprising:

a plurality of playing dice;

a playfield adapted for use of the plurality of dice, the playfield including:

a wagering layout having indicia representing a plurality of different final game results; and

retaining means for retaining selected dice according to the outcome of a first cast of the plurality of dice matching one or more first criteria and, for any remaining dice after the first cast, retaining further selected dice according to the outcome of the first cast of the dice together with the outcome of one or more successive casts of the remaining dice matching one or more successive criteria, respectively.

In preferred forms of the apparatus, the successive criteria comprise second criteria and final criteria. The second criteria may comprise a second outcome from casting the dice having no dice with unique rank. The final criteria may simply comprise retaining all remaining dice regardless of the outcome of the cast.

The retaining means of the apparatus may comprise a predefined gaming layout included in the playfield for accommodating each of the plurality of dice.

The apparatus may further include at least one dice tumbler for casting the dice.

The wagering process of the invention may be implemented as a simulated dice game in at least one electronic device. According to an aspect of the present invention there is provided an apparatus for conducting a wagering process, the apparatus including: electronic processing means adapted to simulate the cast of a plurality of dice, a display controlled by the electronic processing means, the display operatively depicting a playfield having a gaming layout adapted for location of a plurality of dice, and a wagering layout including indicia representing a plurality of different final game results and an input device in operative communication with the electronic processing means by which a player may place bets in relation to at least the plurality of different final game results, wherein the electronic processing means is programmed to pay out wagers placed in relation to a final game result on the basis of the outcome of one or more casts of the dice.

The electronic processing means may use a random number generator to simulate the roll of the die or dice. The apparatus may be a portable electronic device or a personal computer. Alternatively, the apparatus may comprise a dedicated electronic gaming machine.

The wagering process of the invention may be implemented as a simulated dice game in at least one electronic device. According to yet another aspect of the present invention there is provided an apparatus for conducting a wagering process, the apparatus including: electronic processing means adapted to simulate the roll of at least one die, a display controlled by the electronic processing means, the display operatively depicting a playfield as described above, and an input device in operative communication with the electronic processing means by which a player may place wagers in relation to a plurality of game results presented on the playfield, wherein the electronic processing means is programmed to pay out wagers placed in relation to matching final game results according to predetermined payout ratios.

Typically, the display operatively depicts at least one die. The electronic processing means may use a random number generator to simulate the roll of the die or dice.

The apparatus as described above may be a portable electronic device or a personal computer. Alternatively, the apparatus may be a dedicated electronic gaming machine. A plurality of such electronic gaming machines may be operably linked by a local area network, or wider network such as the internet, to form a linked gaming system such as a gaming machine network.

Advantages provided by the present invention comprise the following

From the perspective of a game or casino operator, there is an advantage with the invention over other games as in preferred forms the invention only requires the provision of a printed felt, to be fitted over a standard sized D shaped table. This will overcome the disadvantages of certain existing game variations that are not made in standard sizes and may require the buyer to purchase a full table.

In terms of any additional equipment required, apart from the design of the die retaining means, only a standard set of five dice and a standard shaker is required, both low cost items.

An ability to interact and the simplicity of play for embodiments of the invention as mentioned below and herein are main drawcards for attracting players.

Patrons may be drawn to the use and familiarity of poker hands, found in many other card games for many embodiments of the present invention.

One of the reasons why patrons do not like the appeal of current casino games is the lack of skill required in most games. However, with embodiments of the present invention the player interaction such as the ability to shake the dice gives patrons a sense of control of their destiny and a sense that there is an element of skill as it allows patrons to touch and influence the outcome of the game.

### BRIEF DESCRIPTION OF THE DRAWINGS

Further disclosure, objects, advantages and aspects of the present application may be better understood by those skilled in the relevant art by reference to the following description of exemplary embodiments taken in conjunction with the accompanying drawings, which are given by way of illustration only, and in which:

FIG. 1 depicts a gaming table according to a first described embodiment of the present invention;

FIG. 2 is a plan view of a gaming table playfield according to the first described embodiment of the invention;

FIG. 3 illustrates a player wagering box layout according to the first described embodiment of the invention;

FIG. 4 is a flow chart diagram outlining an instance of game play according to an exemplary embodiment of the present invention;

FIG. 5 illustrates a table of possible game outcomes according to the first described embodiment, with examples of associated wagering payout ratios and house edge percentages;

FIG. 6 is a plan view of another gaming table playfield according to an embodiment of the invention;

FIG. 7 depicts an electronic gaming machine including a software product containing instructions for the machine to execute a method of conducting a wagering process according to an embodiment of the invention;

FIG. 8 depicts the outcomes and payout of a set of base wagers in accordance with a third described embodiment of the invention;

FIG. 9 depicts the outcomes and payout for an additional wager based on an extra roll of dice in accordance with the third described embodiment of the invention; and

FIGS. 10 and 11 depict final outcomes for payout options in a selection of additional dice rolls in accordance with the third described embodiment of the invention;

FIG. 12 depicts a gaming table according to the third described embodiment of the present invention;

FIG. 13 illustrates a player wagering box layout according to a second described embodiment of the invention;

FIG. 13a illustrates an alternate player wagering box layout of preferred embodiments according to the present invention;

FIG. 14 illustrates a table of possible game outcomes according to the second described embodiment, with examples of associated wagering payout ratios and house edge percentages;

FIG. 15 is a plan view of another gaming table playfield according to the second described embodiment of the invention;

FIG. 16 shows an image of an accompanying display screen in accordance with embodiments of the present invention which, displays a history of previous hand results for the benefit of patrons.

### DETAILED DESCRIPTION

The present invention relates to a method and apparatus for conducting a wagering process or gambling using dice. The invention may be implemented using actual physical dice, or simulated on electronic gaming machines, computers or other electronic devices. The invention is suitable for commercial use in casinos or other gaming establishments, or for individual use.

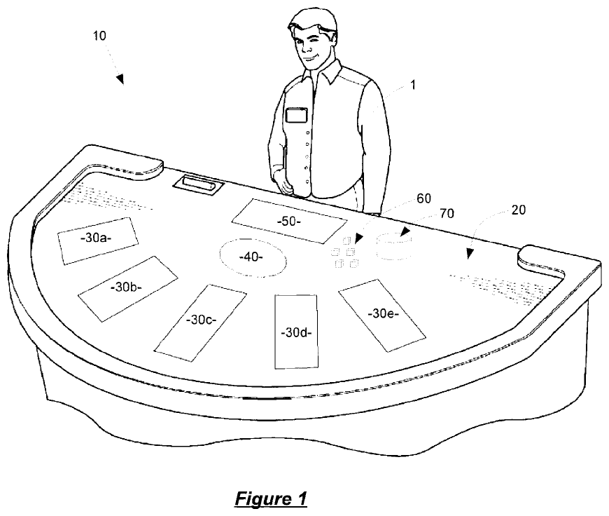

A gaming table 10 according to an embodiment of the invention is depicted in FIG. 1, wherein certain gaming operations are conducted by a dealer 1. The gaming table 10 includes a playfield 20 in the form of an arrangement of gaming indicia on the table surface, for example printed on the surface of a felt overlay. The table structure may be generally similar to known gaming tables, such as those used for Blackjack or the like, adapted to accommodate a plurality of players in a semi-circular or D′ configuration facing the dealer 1. In the embodiment illustrated the gaming table is suitable for five players, with each individual player allocated a respective wagering layout 30(a-e). The playfield 20 additionally includes gaming layouts 40, 50 that are utilised by the dealer during game-play, as explained hereinbelow. The game further employs five standard six-sided dice 60, and a dice tumbler 70 used for ‘throwing’ the dice, in use.

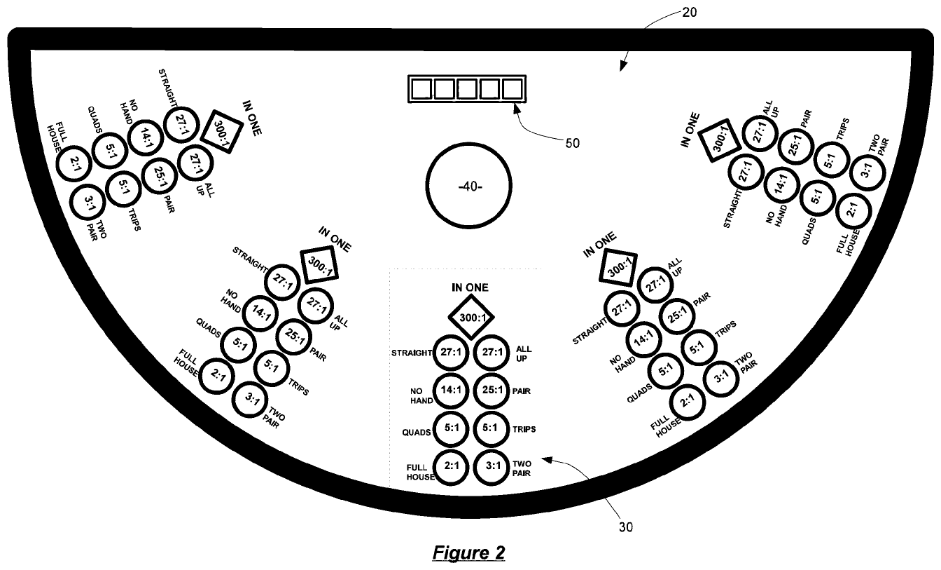

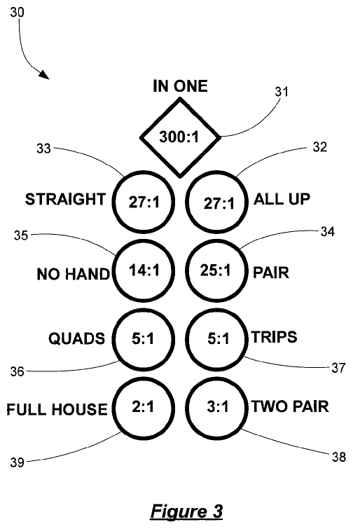

FIG. 2 is a plan view of a playfield 20 according to an exemplary embodiment of the invention for implementation of a game of chance. As described above, each player is allocated a wagering layout 30, whilst the dealer employs gaming layouts 40, 50 as well as conventional facilities for administering gaming tokens and/or cash (not shown). A player wagering layout 30, according to this example, is shown in greater detail in FIG. 3, comprising nine different betting boxes 31-39 representing different game outcomes on which the player make place a wager. In each instance of the game, the game outcome (final result) is determined by five standard six-sided dice.

The game outcomes also have descriptive labels as follows:
IN ONE (box 31)
ALL UP (box 32)
STRAIGHT (box 33)
PAIR (box 34)
NO HAND (box 35)
QUADS (box 36)
TRIPS (box 37)
TWO PAIR (box 38)
FULL HOUSE (box 39)

In execution of the game, the dealer and one or more participating players interact with the physical gaming components as described below.

1. The game starts with the tumbler placed on the central logo (40) with the opening facing up. The five dice are placed on respective markers 50 provided on the playfield.
2. The dealer indicates to players to place their bets. During this period players may place wagers on the available different outcomes by locating gaming tokens (e.g. ‘chips’) on the corresponding indicia 31-39, as desired.
3. After a set amount of time, the dealer indicates to place no more bets.
4. The dealer places all five dice in the tumbler and covers the tumbler with the lid.
5. The dealer hands the tumbler with the dice to a selected player (the player may be selected randomly so that everyone gets a turn, or given to the player with the highest bet, for example) and instructs the player to shake the tumbler.
6. The player shakes the tumbler and then places the tumbler back on the table on the lid (i.e. with the opening facing down).
7. The dealer retrieves the tumbler and slides it over to the logo 40.
8. The dealer slightly ‘wiggles’ the tumbler to ensure that the dice inside are not stacked.
9. The dealer removes the tumbler from the lid, revealing the randomised pattern of the five dice.
10. Depending on the results of the dice cast, the dealer may place one or more retained dice on respective markers provided on the playfield in the layout 50, result facing up. Which dice results are retained are governed by predetermined requirements, detailed below. In an alternate embodiment of the invention described further herein, at this point, a player may be provided with the option of taking a further roll of the dice or opting to refrain from a further roll of the dice.
11. The dealer places all remaining (non-retained) dice back inside the tumbler (if any) and hands it back to a selected player for another cast or ‘roll’ of the dice (the selected player may be the same player as previously, or a player that still has a chance of winning, for example).
12. Steps 6 to 11 are repeated up to a maximum of three times, according to the predetermined game requirements to reach a final game result.
13. When the game is complete, the dealer assesses the wagers placed by participating players against the final game result, retrieves all losing bets (e.g. collects chips), and pays out all winning bets.

The objective of the game in this embodiment is to achieve one of nine possible combinations of dice, the highest-ranking combination being five of a kind in the first roll (“In One”). Other combinations which involve a payout to the player include:

“All Up”—Five dice consisting of five dice of the same rank;
“Quads”—Five dice consisting of four dice of the same rank and an additional die not of the same rank as the other four dice;
“Full House”—Five dice consisting of three dice of the same rank and an additional two dice of the same rank as each other but not the other three dice;
“Trips”—Five dice consisting of three dice of the same rank and an additional two dice not of the same rank as each other or the other three dice;
“Two Pair”—Five dice consisting of two dice of the same rank, a further two dice of the same rank as each other but not the first two dice and an additional die not of the same rank as the other four dice;
“Pair”—Five dice consisting of two dice of the same rank and an additional three dice not of the same rank as each other or the other two dice;
“Straight”—Five dice of consecutive rank where no two dice have the same rank and 1 and 6 are not consecutive ranks;
“No Hand”—Any combination of five dice that does not constitute a All Up, Quads, Full House, Trips, Two Pair, Pair or Straight hand.

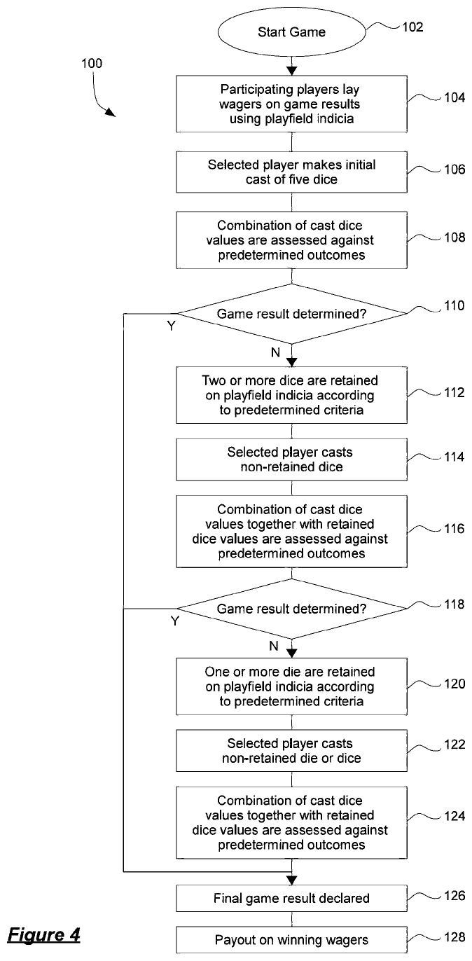

The game procedure 100 of this embodiment is outlined in the form of a flow chart diagram in FIG. 4 comprising a sequence of operations 102-128. Starting at operation 102, the game is played as follows:

1. There are nine permissible wagers that a player may place. A participating player must place at least one and may place up to all nine of the wagers (operation 104).
2. A selected player casts the five dice (operation 106).
3. If none of the dice have the same rank or if for every die there exists at least one other die with the same rank then the round is complete and the five dice make up the final game result (operations 108, 110).
4. Otherwise, any dice that have the same rank as any single other die are retained and the remaining dice with unique rank are rolled again (operations 112, 114).
5. If there are no dice with unique rank following this roll then the round is complete and the five dice make up the final game result (operations 116, 118).
6. Otherwise, any dice that have the same rank as any single other die (including the previously retained dice) are also retained and the remaining dice with unique rank are rolled again (operations 120, 122). Following this roll, the round is always complete and the five dice make up the final game result (operations 124, 126).
7. Player wagers are assessed against the final game result, and winning wagers are paid according to predetermined payout ratios; losing wagers are collected (operation 128).

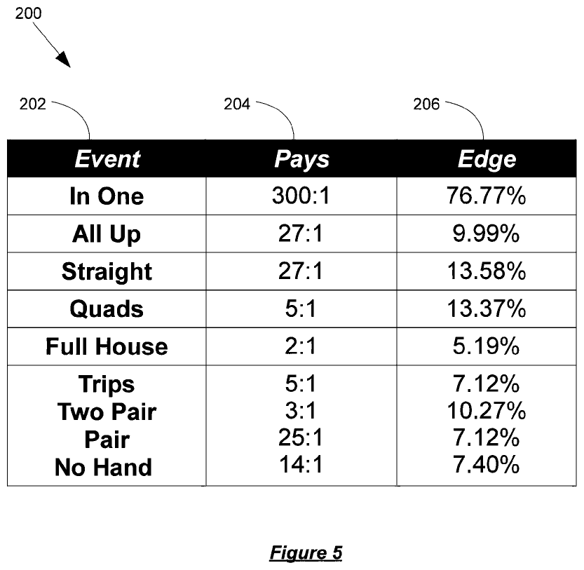

FIG. 5 illustrates a table 200 listing the various wager types (column 202) along with corresponding payout ratios (column 204) and house edge percentages (column 206) for the game as above described and as depicted on the layout 30 shown in FIG. 3. The payouts shown in the Figures are illustrative only and the actual offered payout ratios, and therefore house edge, will ultimately be determined by the casino or other service provider offering the embodiments of the present invention to its patrons.

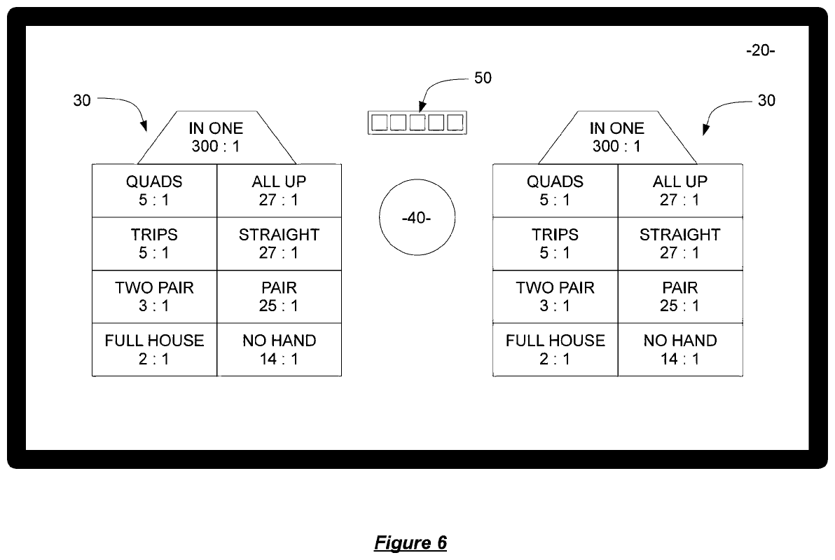

Whilst the table in FIG. 1 and the playfield as shown in FIG. 2 are adapted for several players seated around the table, each having a corresponding wagering layout, FIG. 6 illustrates an alternative playfield layout adapted for a multitude of standing players. In this case the playfield 20 has two large sets of boxes 30 for betting that are shared amongst standing players. Each player can place chips in up to nine locations, one location for each bet, with the highest paid bet indicia (“In One”) located in a trapezoid shape located closest to the dealer. A central, circular logo (40) is situated in the middle of the layout, which serves as a resting place for the dice tumbler, in use, and markings (50) are provided to indicate where the dice rest when retained during the game and following determination of the final game result.

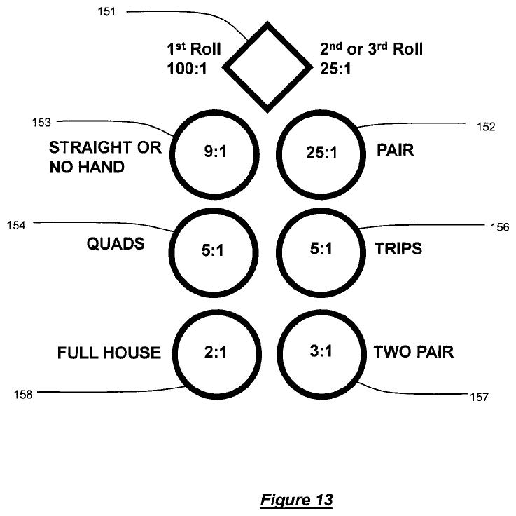

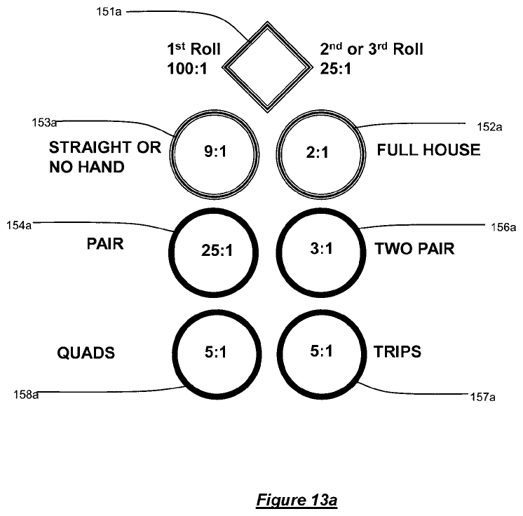

In an alternate or second embodiment to that described herein immediately above, the game process and apparatus are substantially similar to that as described above but with an alteration to the game outcomes that can be wagered upon. In this embodiment, the objective is to achieve one of seven (7) possible outcomes upon a first roll of the dice or to achieve one of the same seven (7) possible outcomes upon a second or subsequent roll of the dice. The alteration in this embodiment is effectively the merger of the “IN ONE” and “ALL UP” outcomes and the merger of the “STRAIGHT” and the “NO HAND” outcomes described above in the first embodiment. FIG. 13 is a player wagering box layout adapted for this alternate embodiment of outcomes. In preferred embodiments of the invention, the player wagering box layout of FIG. 13a is used. In the betting box arrangement of FIG. 13a the alternate bordered labels referenced as 151a, 152a and 153a indicate results that do not require any more rolls or shakes of the dice. The betting box layouts as shown in FIG. 13a are arranged in this way for operational reasons, which firstly helps the dealers recognise when to shake or not shake again. Accordingly, as stated, if a player achieves one of the hands indicated by the alternately bordered labels 151a, 152a and 153a, then there is no need to shake again. Outside of the bets labelled 151a, 152a and 153a in the alternate bordering, ‘pair’ is positioned next closest to the dealer as it has the highest odds so it needs to be as close to the dealer as possible for security reasons. Lastly the two betting options with the same odds are next to each other for ease of paying out.

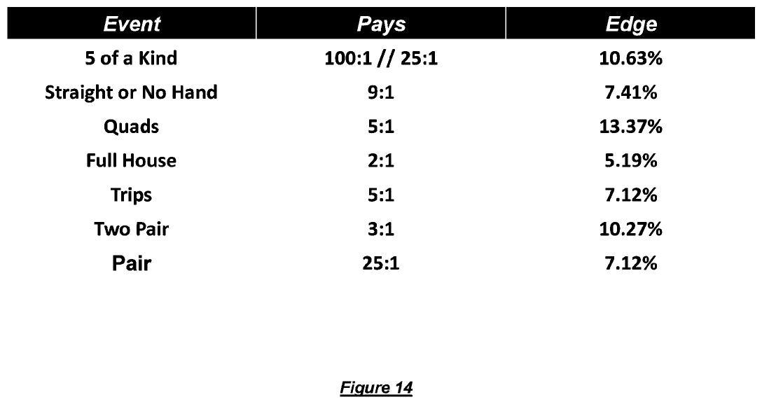

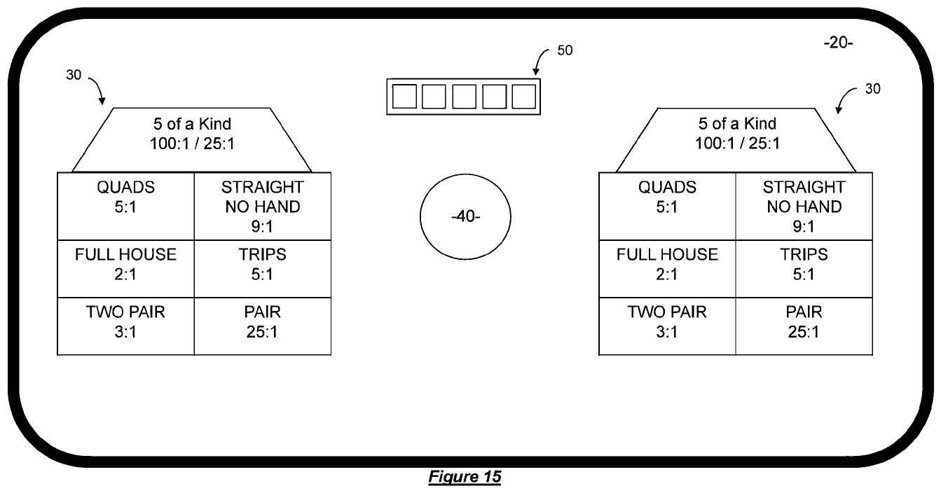

FIG. 14 is a table of the outcomes associated with this alternate embodiment utilising the player wagering box layouts of FIGS. 13 and 13a. FIG. 15 is a plan view of a gaming table playfield that is adapted to the alternate outcomes depicted in FIG. 14 using the player wagering box layout of FIG. 13. Like reference numerals are used in FIG. 15 to indicate the corresponding features depicted in FIGS. 1 and 6.

In this second embodiment with now seven (7) permissible wagers as opposed to nine (9) illustrated above, the corresponding game outcomes having descriptive labels as follows:
FIVE OF A KIND (box 151)—1^{st} roll odds of 100:1; 2^{nd} or 3^{rd} roll odds of 25:1
PAIR (box 152)
STRAIGHT or NO HAND (box 153)
QUADS (box 154)
TRIPS (box 156)
TWO PAIR (box 157)
FULL HOUSE (box 158)

The calculations provided below are determined by systematically counting all possible combinations of dice in the outcomes of the second described embodiment of the game as described above.

| Event | Outcome | Payout | Permutations | Probability |
|---|---|---|---|---|
| 1 Spin | Win | 100 | 279,936 | 0.07716% |
| 2 Spin | Win | 25 | 3,499,200 | 0.96451% |
| 3 Spin | Win | 25 | 7,884,000 | 2.17312% |
| Other Hands | Lose | −1 | 351,133,920 | 96.7852% |
| | | | 362,797,056 | 100.0000% |
| | | | House Edge | 10.6286% |
| Straight | Win | 9 | 11,197,440 | 3.0864% |
| No Hand | | 9 | 22,394,880 | 6.1728% |
| Other Hands | Lose | −1 | 329,204,736 | 90.7407% |
| | | | 362,797,056 | 100.0000% |
| | | | House Edge | 7.4074% |
| Quads | Win | 5 | 52,380,000 | 14.4378% |
| Other Hands | Lose | −1 | 310,417,056 | 85.5622% |
| | | | 362,797,056 | 100.0000% |
| | | | House Edge | 13.3731% |
| Full House | Win | 2 | 114,652,800 | 31.6025% |
| Other Hands | Lose | −1 | 248,144,256 | 68.3975% |
| | | | 362,797,056 | 100.0000% |
| | | | House Edge | 5.1926% |
| Trips | Win | 5 | 56,160,000 | 15.4797% |
| Other Hands | Lose | −1 | 306,637,056 | 84.5203% |
| | | | 362,797,056 | 100.0000% |
| | | | House Edge | 7.1216% |
| Two Pair | Win | 3 | 81,388,800 | 22.4337% |
| Other Hands | Lose | −1 | 281,408,256 | 77.5663% |
| | | | 362,797,056 | 100.0000% |
| | | | House Edge | 10.2652% |
| Pair | Win | 25 | 12,960,000 | 3.5722% |
| Other Hands | Lose | −1 | 349,837,056 | 96.4278% |
| | | | 362,797,056 | 100.0000% |
| | | | House Edge | 7.1216% |

As may further be apparent to those skilled in the relevant art, payout odds such as those indicated in the table above may be varied for given outcomes within the scope of the present invention and any of its described embodiments. For example, a Trips outcome described herein above with a payout of 5:1 with its corresponding house edge of 7.12% could alternatively be utilised with a payout of 4:1 with a house edge of 22%. The invention can also be embodied in a wide variety and forms of other media such as single player slot video machines, multi-player slot video machines, electronic games and devices, software, as well as in-flight, home and Internet entertainment. In addition, the invention can be readily implemented as a computer program product (e.g., floppy disk, compact disc, memory stick, etc.) comprising a computer readable medium having control logic recorded therein to implement the features of the invention as described in relation to the other preferred embodiments. Control logic can be loaded into the memory of a computer and executed by a central processing unit (CPU) to perform the operations described herein.

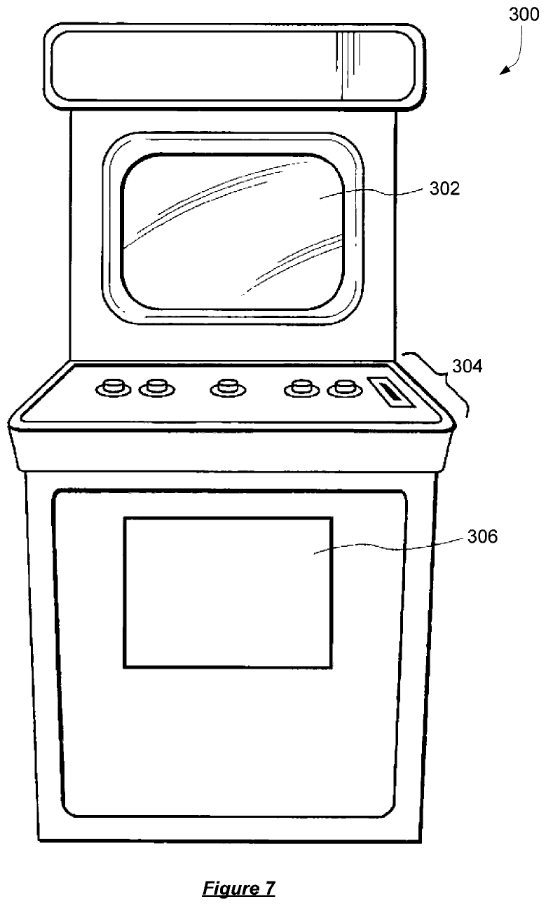

In this context, referring to FIG. 7, a schematic arrangement is illustrated showing the components of an apparatus 300 configured for playing the game according to the invention. The apparatus includes a display 302, a player interface 304, and circuitry 306 such as a CPU for effecting game play according to the rules of the game. The operation of electronic gaming machines in general, such as slot machines and video poker machines, is well known in the industry so that the minute details are not set forth herein. In general terms, electronic gaming machines are controlled by processors including, or in communication with, a random number generator. The random number generator ultimately determines the game outcomes, in this case the casts of the dice. A display in communication with the processor provides visual and graphic information to players. The processor then controls the game play and associated operations, including tracking wagers and payouts.

The general external features of the gaming machine 300 may include a display, coin slot and/or banknote reader, a card reader and a credit display. The gaming machine may also include several player buttons which act as interfaces between the player and the machine processor, such as for making wager selections and amounts, and for casting the dice button. It is noted that any of the functions facilitated by the gaming machine buttons can alternatively be accomplished using a display employing touch-screen technology.

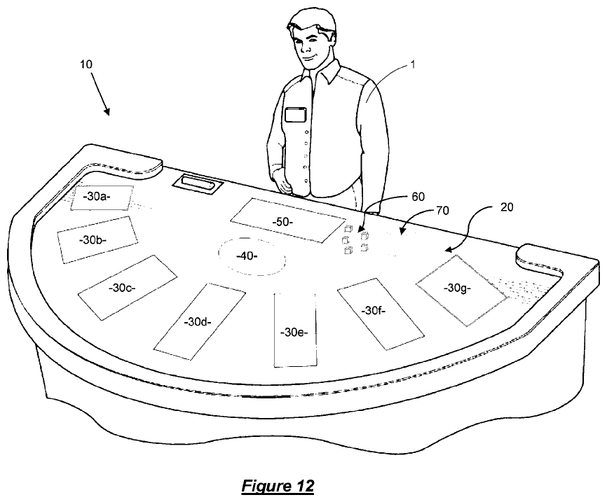

Further to the above a third described embodiment of the invention involves a table game where players roll five dice to make a winning combination. Players may have a range of betting options paying even money and up to 100:1. The wager involving a bonus ‘lucky’ roll in addition to base wagers gives patrons a second chance to win with larger odds. FIG. 12 depicts a gaming table adapted from the gaming table of FIG. 1 according to the third described embodiment of the present invention where like reference numerals are used for the corresponding features shown in FIG. 1. Notably, in contrast to the first described embodiment, two additional wager layouts, eg 30f and 30g are included in the gaming table of FIG. 12.

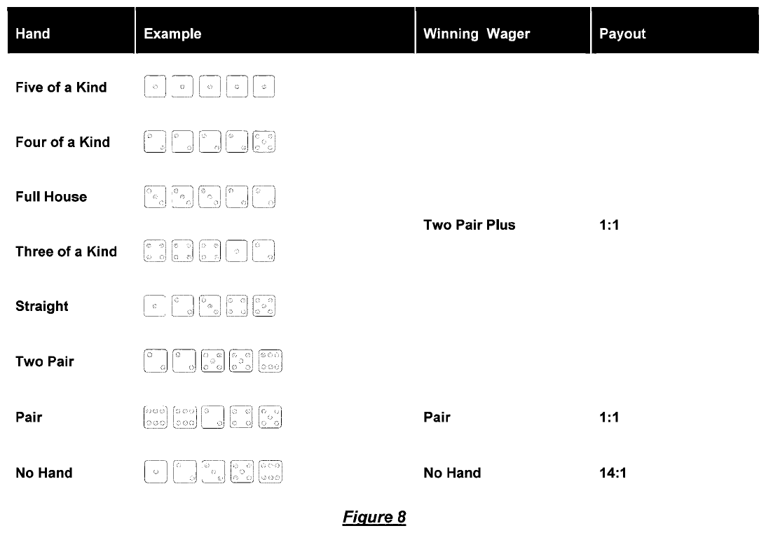

In accordance with this embodiment there is provided an entry level product, player interaction, social gaming, with different pay tables available. In one form, based on poker style hands the results payout table of FIG. 8 applies for base wagers. There are three base wagers that appeal to a Poker style hand structure in this embodiment, namely, (1) ‘PAIR, (2) TWO PAIR PLUS and, (3) NO HAND. For the ‘Pair’ wager a win occurs in the event of a single pair and loses in all other instances. This will pay even Money with a House Edge of 7.41%. For the Two Pair Plus' wager a win occurs in the event of two pair or better and loses in all other instances. So winning events consist of Two Pair, Straight, Three of a Kind, Full House, Four of a Kind, and Five of a Kind. This will pay even money with a House Edge of 4.94%. For the ‘No Hand’ wager a win occurs in the event that there are no matching dice and the dice are not consecutive. This pays 14 to 1 with a House Edge of 7.41%. Payout odds and winning event combinations may be customisable.

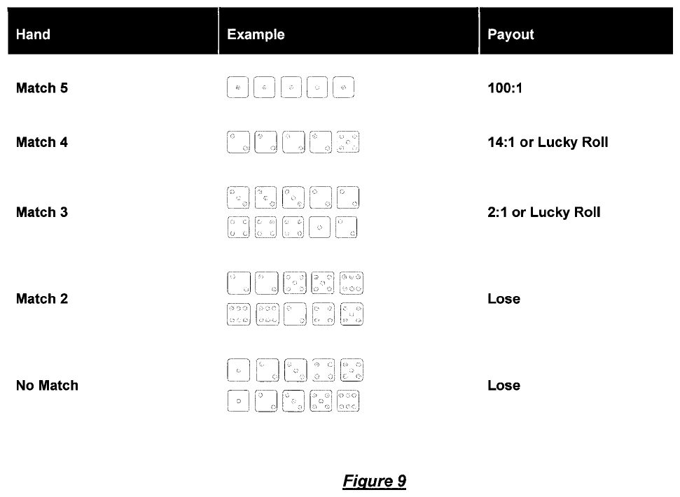

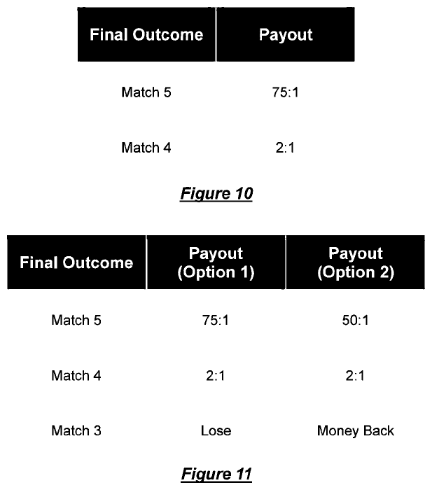

With reference to FIGS. 9 to 11 the bonus ‘Lucky’ roll wager is based on the largest number of matched dice in the initial roll. Players have the option to take the odds offered in the initial pay table or roll the unmatched die/dice again for a chance at accentuated odds. This requires the player to risk the odds they have already won. House Edge (relative to the pay tables given) is between 5.08% and 6.47% depending on how the player chooses to play. Payout odds and winning event combinations are customisable. FIG. 10 shows the payout table for match 4 outcomes and FIG. 11 shows the payout table for match 3 outcomes.

The ‘Lucky’ roll embodiment is a stand-alone table game not based on the result of any other proprietary table game. As is evident in FIGS. 8 to 11 and in accordance with preferred embodiments of the invention, results in the game are determined by five standard six sided dice. In this preferred embodiment, the game comprises four wager options. Three wagers (Pair, Two Pair Plus, No Hand) are based on poker style rankings as follows:
Five of a Kind—Five dice all of the same rank.
Four of a Kind—Five dice consisting of four dice of the same rank and an additional die not of the same rank as the other four dice.
Full House—Five dice consisting of three dice of the same rank and an additional two dice of the same rank as each other but not the other three dice.
Three of a Kind—Five dice consisting of three dice of the same rank and an additional two dice not of the same rank as each other or the other three dice.
Straight—Five dice of consecutive rank where no two dice have the same rank and 1 and 6 are not consecutive ranks.
Two Pair—Five dice consisting of two dice of the same rank, a further two dice of the same rank as each other but not the first two dice and an additional die not of the same rank as the other four dice.
Pair—Five dice consisting of two dice of the same rank and an additional three dice not of the same rank as each other or the other two dice.
No Hand—Any combination of five dice that does not constitute a Five of a Kind, Four of a Kind, Full House, Three of a Kind, Two Pair, Pair or Straight hand.

The remaining wager (directed to the ‘Lucky’ roll) is based on the largest number of matching dice in the hand as follows:
Five Match—Five Dice all of the same rank (called the matched dice).
Four Match—Five dice consisting of four dice of the same rank (called the matched dice) and an additional die not of the same rank as the other four dice (called the unmatched die).
Three Match—Five dice consisting of three dice of the same rank (called the matched dice) and an additional two dice not of the same rank as the other three dice (called the unmatched dice).
Two Match—Five dice consisting of two dice of the same rank as each other and remaining dice such that a Three Match, Four Match and Five Match have not been achieved.
No Match—Five dice where no two dice have the same rank

The game is played as follows:

1. A player must place at least one and may place up to all four of the wagers.
2. The player rolls five dice.
3. Pair, Two Pair and No Hand wagers are settled according to the result generated by this roll. If the result is a Five Match, Two Match or No Match then ‘Lucky’ roll wagers are also settled and the round is complete.
4. Otherwise, the result is a Three Match or a Four Match. In this case, players will be given the option to take the “First Round” payout or “Lucky Roll”. In the event that the player chooses to take the “First Round” payout their wager will be settled according to the First Round pay table below and the round is complete.
5. Otherwise, the player elects to “Lucky Roll”. In this case, the player will roll the unmatched die/dice (as defined in the hand rankings above). The result of this roll will be combined with the matched dice from the first spin to make a five dice hand. The wager will then be settled according to the Second Round pay table below and the round is complete.

Pay Tables

| | | Second Round Pay | Second Round Pay |
|---|---|---|---|
| | | Table (Given Four | Table (Given |
| | First Round Pay | of a Kind in initial | Three of a Kind in |
| Outcome | Table | roll) | initial roll) |
| Match 5 | 100 | 75 | 50 |
| Match 4 | 14 | 2 | 2 |
| Match 3 | 2 | — | 0 |
| Match 2 | −1 | — | — |
| Match 1 | −1 | — | — |

Notably there are four strategy variations for a Lucky Roll wager. The edge calculations for all strategy variations may be included as follows:
Strategy 1—The player elects to take first round payout on all occasions.
Strategy 2—The player elects to take first round payout when they have Three of a Kind but Lucky Roll when they have Four of a Kind.
Strategy 3—The player elects to take first round payout when they have Four of a Kind but Lucky Roll when they have Three of a Kind.
Strategy 4—The player elects to Lucky Roll on all occasions.

The calculations provided below are determined by systematically counting all possible combinations of dice in the ‘Lucky Roll’ game as described above.

Pair Wager − House Edge = 7.4074%

| Event | Outcome | Payout | Permutations | Probability |
|---|---|---|---|---|
| Five of a Kind | Lose | −1 | 6 | 0.0772% |
| Four of a Kind | Lose | −1 | 150 | 1.9290% |
| Full House | Lose | −1 | 300 | 3.8580% |
| Three of a Kind | Lose | −1 | 1,200 | 15.4321% |
| Straight | Lose | −1 | 240 | 3.0864% |
| Two Pair | Lose | −1 | 1,800 | 23.1481% |
| Pair | Win | 1 | 3,600 | 46.2963% |
| No Hand | Lose | −1 | 480 | 6.1728% |
| | | | 7,776 | 100.0000% |

Two Pair Plus − House Edge = 4.9383%

| Event | Outcome | Payout | Permutations | Probability |
|---|---|---|---|---|
| Five of a Kind | Win | 1 | 6 | 0.0772% |
| Four of a Kind | Win | 1 | 150 | 1.9290% |
| Full House | Win | 1 | 300 | 3.8580% |
| Three of a Kind | Win | 1 | 1,200 | 15.4321% |
| Straight | Win | 1 | 240 | 3.0864% |
| Two Pair | Win | 1 | 1,800 | 23.1481% |
| Pair | Lose | −1 | 3,600 | 46.2963% |
| No Hand | Lose | −1 | 480 | 6.1728% |
| | | | 7,776 | 100.0000% |

No Hand − House Edge = 7.4074%

| Event | Outcome | Payout | Permutations | Probability |
|---|---|---|---|---|
| Five of a Kind | Lose | −1 | 6 | 0.0772% |
| Four of a Kind | Lose | −1 | 150 | 1.9290% |
| Full House | Lose | −1 | 300 | 3.8580% |
| Three of a Kind | Lose | −1 | 1,200 | 15.4321% |
| Straight | Lose | −1 | 240 | 3.0864% |
| Two Pair | Lose | −1 | 1,800 | 23.1481% |
| Pair | Lose | −1 | 3,600 | 46.2963% |
| No Hand | Win | 14 | 480 | 6.1728% |
| | | | 7,776 | 100.0000% |

Strategy 1 − House Edge = 5.4012%

| Event | Outcome | Payout | Permutations | Probability |
|---|---|---|---|---|
| Match 5 | Win | 100 | 6 | 0.0772% |
| Match 4 | Win | 14 | 150 | 1.9290% |
| Match 3 | Win | 2 | 1,500 | 19.2901% |
| Match 2 | Lose | −1 | 5,400 | 69.4444% |
| Match 1 | Lose | −1 | 720 | 9.2593% |
| | | | 7,776 | 100.0000% |

Strategy 2 − House Edge = 5.0797%

| Event | Outcome | Payout | Permutations | Probability |
|---|---|---|---|---|
| Match 5 | Win | 100 | 36 | 0.0772% |
| Match 5 (After | Win | 75 | 150 | 0.3215% |
| Lucky Roll on | | | | |
| Match 4) | | | | |
| Match 4 (After | Win | 2 | 750 | 1.6075% |
| Lucky Roll on | | | | |
| Match 4) | | | | |
| Match 3 | Win | 2 | 9,000 | 19.2901% |
| Match 2 | Lose | −1 | 32,400 | 69.4444% |
| Match 1 | Lose | −1 | 4,320 | 9.2593% |
| | | | 46,656 | 100.0000% |

Strategy 3 − House Edge = 6.4729%

| Event | Outcome | Payout | Permutations | Probability |
|---|---|---|---|---|
| Match 5 | Win | 100 | 216 | 0.0772% |
| Match 4 | Win | 14 | 5,400 | 1.9290% |
| Match 5 (After | Win | 50 | 1,500 | 0.5358% |
| Lucky Roll on | | | | |
| Match 3) | | | | |
| Match 4 (After | Win | 2 | 15,000 | 5.3584% |
| Lucky Roll on | | | | |
| Match 3) | | | | |
| Match 3 (After | Push | 0 | 37,500 | 13.3959% |
| Lucky Roll on | | | | |
| Match 3) | | | | |
| Match 2 | Lose | −1 | 194,400 | 69.4444% |
| Match 1 | Lose | −1 | 25,920 | 9.2593% |
| | | | 279,936 | 100.0000% |

Strategy 4 − House Edge = 6.1514%

| Event | Outcome | Payout | Permutations | Probability |
|---|---|---|---|---|
| Match 5 | Win | 100 | 216 | 0.0772% |
| Match 5 (After | Win | 75 | 900 | 0.3215% |
| Lucky Roll on | | | | |
| Match 4) | | | | |
| Match 4 (After | Win | 2 | 4,500 | 1.6075% |
| Lucky Roll on | | | | |
| Match 4) | | | | |
| Match 5 (After | Win | 50 | 1,500 | 0.5358% |
| Lucky Roll on | | | | |
| Match 3) | | | | |
| Match 4 (After | Win | 2 | 15,000 | 5.3584% |
| Lucky Roll on | | | | |
| Match 3) | | | | |
| Match 3 (After | Push | 0 | 37,500 | 13.3959% |
| Lucky Roll on | | | | |
| Match 3) | | | | |
| Match 2 | Lose | −1 | 194,400 | 69.4444% |
| Match 1 | Lose | −1 | 25,920 | 9.2593% |
| | | | 279,936 | 100.0000% |

Alternate pay tables for the “Lucky Roll” embodiment described above are as follows.

Pay Tables

| | First | | |
|---|---|---|---|
| | Round | Second Round Pay | Second Round Pay |
| | Pay | Table (Given Match 4 | Table (Given Match 3 |
| Outcome | Table | in initial roll) | in initial roll) |
| Match 5 | 100 | 35 | 20 |
| Match 4 | 14 | 10 | 3 |
| Match 3 | 2 | — | 1 |
| Other | −1 | — | — |
| Combinations | | | |

Again, there are four strategy variations for a Lucky Roll wager. The edge calculations for all strategy variations may be included as follows:
Strategy 1—The player elects to take first round payout on all occasions.
Strategy 2—The player elects to take first round payout when they have Match 3 but Lucky Roll when they have Match 4.
Strategy 3—The player elects to take first round payout when they have Match 4 but Lucky Roll when they have Match 3.
Strategy 4—The player elects to Lucky Roll on all occasions.

The calculations provided below are determined by systematically counting all possible combinations of dice in the ‘Lucky Roll’ game as described above.

Pair Wager − House Edge = 7.4074%

| Event | Outcome | Payout | Permutations | Probability |
|---|---|---|---|---|
| Five of a Kind | Lose | −1 | 6 | 0.0772% |
| Four of a Kind | Lose | −1 | 150 | 1.9290% |
| Full House | Lose | −1 | 300 | 3.8580% |
| Three of a Kind | Lose | −1 | 1,200 | 15.4321% |
| Straight | Lose | −1 | 240 | 3.0864% |
| Two Pair | Lose | −1 | 1,800 | 23.1481% |
| Pair | Win | 1 | 3,600 | 46.2963% |
| No Hand | Lose | −1 | 480 | 6.1728% |
| | | | 7,776 | 100.0000% |

Two Pair Plus − House Edge = 4.9383%

| Event | Outcome | Payout | Permutations | Probability |
|---|---|---|---|---|
| Five of a Kind | Win | 1 | 6 | 0.0772% |
| Four of a Kind | Win | 1 | 150 | 1.9290% |
| Full House | Win | 1 | 300 | 3.8580% |
| Three of a Kind | Win | 1 | 1,200 | 15.4321% |
| Straight | Win | 1 | 240 | 3.0864% |
| Two Pair | Win | 1 | 1,800 | 23.1481% |
| Pair | Lose | −1 | 3,600 | 46.2963% |
| No Hand | Lose | −1 | 480 | 6.1728% |
| | | | 7,776 | 100.0000% |

No Hand − House Edge = 7.4074%

| Event | Outcome | Payout | Permutations | Probability |
|---|---|---|---|---|
| Five of a Kind | Lose | −1 | 6 | 0.0772% |
| Four of a Kind | Lose | −1 | 150 | 1.9290% |
| Full House | Lose | −1 | 300 | 3.8580% |
| Three of a Kind | Lose | −1 | 1,200 | 15.4321% |
| Straight | Lose | −1 | 240 | 3.0864% |
| Two Pair | Lose | −1 | 1,800 | 23.1481% |
| Pair | Lose | −1 | 3,600 | 46.2963% |
| No Hand | Win | 14 | 480 | 6.1728% |
| | | | 7,776 | 100.0000% |

Strategy 1 − House Edge = 5.4012%

| Event | Outcome | Payout | Permutations | Probability |
|---|---|---|---|---|
| Match 5 | Win | 100 | 6 | 0.0772% |
| Match 4 | Win | 14 | 150 | 1.9290% |
| Match 3 | Win | 2 | 1,500 | 19.2901% |
| Match 2 | Lose | −1 | 5,400 | 69.4444% |
| Match 1 | Lose | −1 | 720 | 9.2593% |
| | | | 7,776 | 100.0000% |

Strategy 2 − House Edge = 5.0797%

| Event | Outcome | Payout | Permutations | Probability |
|---|---|---|---|---|
| Match 5 | Win | 100 | 36 | 0.0772% |
| Match 5 (After | Win | 35 | 150 | 0.3215% |
| Lucky Roll on | | | | |
| Match 4) | | | | |
| Match 4 (After | Win | 10 | 750 | 1.6075% |
| Lucky Roll on | | | | |
| Match 4) | | | | |
| Match 3 | Win | 2 | 9,000 | 19.2901% |
| Match 2 | Lose | −1 | 32,400 | 69.4444% |
| Match 1 | Lose | −1 | 4,320 | 9.2593% |
| | | | 46,656 | 100.0000% |

Strategy 3 − House Edge = 3.7937%

| Event | Outcome | Payout | Permutations | Probability |
|---|---|---|---|---|
| Match 5 | Win | 100 | 216 | 0.0772% |
| Match 4 | Win | 14 | 5,400 | 1.9290% |
| Match 5 (After | Win | 20 | 1,500 | 0.5358% |
| Lucky Roll on | | | | |
| Match 3) | | | | |
| Match 4 (After | Win | 3 | 15,000 | 5.3584% |
| Lucky Roll on | | | | |
| Match 3) | | | | |
| Match 3 (After | Push | 1 | 37,500 | 13.3959% |
| Lucky Roll on | | | | |
| Match 3) | | | | |
| Match 2 | Lose | −1 | 194,400 | 69.4444% |
| Match 1 | Lose | −1 | 25,920 | 9.2593% |
| | | | 279,936 | 100.0000% |

Strategy 4 − House Edge = 3.4722%

| Event | Outcome | Payout | Permutations | Probability |
|---|---|---|---|---|
| Match 5 | Win | 100 | 216 | 0.0772% |
| Match 5 (After | Win | 35 | 900 | 0.3215% |
| Lucky Roll on | | | | |
| Match 4) | | | | |
| Match 4 (After | Win | 10 | 4,500 | 1.6075% |
| Lucky Roll on | | | | |
| Match 4) | | | | |
| Match 5 (After | Win | 20 | 1,500 | 0.5358% |
| Lucky Roll on | | | | |
| Match 3) | | | | |
| Match 4 (After | Win | 3 | 15,000 | 5.3584% |
| Lucky Roll on | | | | |
| Match 3) | | | | |
| Match 3 (After | Push | 1 | 37,500 | 13.3959% |
| Lucky Roll on | | | | |
| Match 3) | | | | |
| Match 2 | Lose | −1 | 194,400 | 69.4444% |
| Match 1 | Lose | −1 | 25,920 | 9.2593% |
| | | | 279,936 | 100.0000% |

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

The following sections I-VII provide a guide to interpreting the present specification.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of” each of the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically, a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

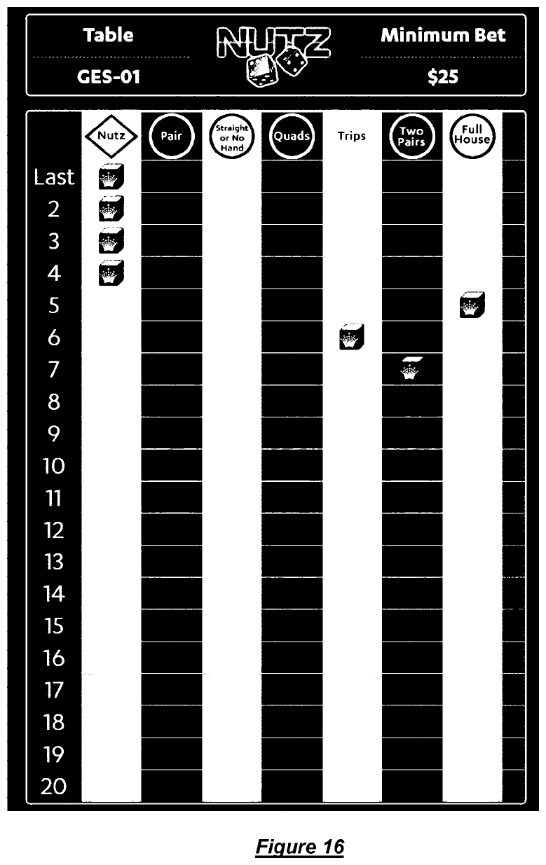

Furthermore, an accompanying display screen may be provided with any or all embodiments envisaged by the present invention, which displays previous hand results. Such a history of previous hands being displayed will provide patrons with a better sense of the more common game results being achieved, and to allow patrons to bet based on trends. An exemplary display screen of previous hand results that is suitable for use with at least the first and second embodiments described herein is shown in FIG. 16. Whilst not shown in the drawings, a similar history of previous hands may also be displayed in accordance with the other embodiments described herein.

Where a process is described, in an embodiment the process may operate without any user intervention. In another embodiment, the process includes some human intervention (e.g., a step is performed by or with the assistance of a human).

We claim:

1. A method of conducting a wagering process comprising the steps of:
(i) providing a playfield including a gaming layout adapted for location of a plurality of dice, and a wagering layout having indicia representing a plurality of different final game results;
(ii) accepting placement of a wager, through use of said playfield wagering layout, in relation to a selected one of the plurality of final game results;
(iii) casting a plurality of dice on said playfield so as to generate a first outcome;
(iv) determining whether the first outcome matches one or more first criteria and, if so, declaring the first outcome to be the final game result;
(v) otherwise, retaining two or more of the dice on the gaming layout and re-casting the non-retained die or dice, wherein the outcome of the retained dice together with the re-cast non-retained die or dice constitute a second outcome;
(vi) determining whether the second outcome matches one or more second criteria and, if so, declaring the second outcome to be the final game result;
(vii) otherwise, retaining one or more additional dice on the gaming layout and re-casting the non-retained die or dice, wherein the outcome of the retained dice together with the re-cast non-retained die or dice constitute the final game result; and
(viii) settling the wager on the basis of the final game result.

2. A method as claimed in claim 1, wherein the first criteria comprises the first outcome having none of the dice with the same rank and/or for every die there existing at least one other die with the same rank.

3. A method as claimed in claim 2, wherein step (v) comprises retaining any dice that have the same rank as any single other die and re-casting the remaining dice with unique rank.

4. A method as claimed in 3 wherein the second criteria comprises the second outcome having no dice with unique rank.

5. A method as claimed in claim 4 wherein the die or dice that are re-cast in step (vii) comprise those that have a unique rank.

6. A method as claimed in claim 1 wherein the plurality of dice comprises five standard six-sided dice.

7. A method as claimed in claim 6 wherein the final game results comprise:
(a) five dice consisting of five dice of the same rank;
(b) five dice consisting of four dice of the same rank and an additional die not of the same rank as the other four dice;
(c) five dice consisting of three dice of the same rank and an additional two dice of the same rank as each other but not the other three dice;
(d) five dice consisting of three dice of the same rank and an additional two dice not of the same rank as each other or the other three dice;
(e) five dice consisting of two dice of the same rank, a further two dice of the same rank as each other but not the first two dice and an additional die not of the same rank as the other four dice;
(f) five dice consisting of two dice of the same rank and an additional three dice not of the same rank as each other or the other two dice;
(g) five dice of consecutive rank where no two dice have the same rank and 1 and 6 are not consecutive ranks.
(h) any combination of five dice that does not constitute a result as defined in (a) to (g).

8. A method as claimed in claim 1, wherein one or more of the method steps are implemented by computer simulation.

9. Apparatus for conducting a wagering process comprising:
a plurality of playing dice;
a playfield adapted for use of the plurality of dice, the playfield including:
a wagering layout having indicia representing a plurality of different final game results; and
retaining means for retaining selected dice according to the outcome of a first cast of the plurality of dice matching one or more first criteria and, for any remaining dice after the first cast, retaining further selected dice according to the outcome of the first cast of the dice together with the outcome of one or more successive casts of the remaining dice matching one or more successive criteria, respectively.

10. Apparatus as claimed in claim 9 wherein the successive criteria comprise a second criteria and a final criteria.

11. Apparatus as claimed in claim 9 wherein the retaining means comprises a predefined gaming layout included in the playfield for accommodating each of the plurality of dice.

12. Apparatus as claimed in claim 9, further including at least one dice tumbler for casting the dice.

13. Apparatus for conducting a wagering process comprising:
electronic processing means adapted to simulate the roll of at least one die;
a display controlled by the electronic processing means, the display operatively depicting a playfield, the playfield including a gaming layout adapted for location of a plurality of dice, and a wagering layout having indicia representing a plurality of different final game results, and;
an input device in operative communication with the electronic processing means by which a player may place wagers in relation to a plurality of game results presented on the playfield, wherein the electronic processing means is programmed to pay out wagers placed in relation to matching final game results according to predetermined payout ratios.

14. Apparatus for conducting a wagering process, the apparatus including:
electronic processing means adapted to simulate the cast of a plurality of dice;
a display controlled by the electronic processing means, the display operatively depicting a playfield having a gaming layout adapted for location of a plurality of dice, and a wagering layout including indicia representing a plurality of different final game results and;
an input device in operative communication with the electronic processing means by which a player may place bets in relation to at least the plurality of different final game results, wherein the electronic processing means is programmed to pay out wagers placed in relation to a final game result on the basis of the outcome of one or more casts of the dice.

15. Apparatus as claimed in claim 13, wherein the electronic processing means uses a random number generator to simulate the roll of the die or dice.

16. Apparatus as claimed in claim 13, wherein the apparatus comprises one or a combination of:
a portable electronic device;
a personal computer;
a dedicated electronic gaming machine.

17. An electronic gaming machine network comprising a plurality of operably connected electronic gaming apparatus, wherein each electronic gaming apparatus is adapted for conducting a wagering process and comprises:
electronic processing means adapted to simulate the roll of at least one die;
a display controlled by the electronic processing means, the display operatively depicting a playfield, the playfield including a gaming layout adapted for location of a plurality of dice, and a wagering layout having indicia representing a plurality of different final game results, and;
an input device in operative communication with the electronic processing means by which a player may place wagers in relation to a plurality of game results presented on the playfield, wherein the electronic processing means is programmed to pay out wagers placed in relation to matching final game results according to predetermined payout ratios.

18. (canceled)

19. (canceled)
